(19) United States
(12) Patent Application Publication
(10) Pub. No.: US 2005/0104374 A1
(43) Pub. Date: May 19, 2005

(54) Pull-out resistant compression fitting for fluid lines

(76) Inventor: Gunnar Van der Steur, Chesapeake City, MD (US)

Correspondence Address: E. Alan Uebler, Esq.;E. Alan Uebler, PA, Lindell Square, Suite 4, 1601 Milltown Road, Wilmington, DE, 19808, US

(21) Appl. No.: 10/714,777

(22) Filed: Nov. 17, 2003

(51) Int. Cl. F16L 33/00

(52) U.S. Cl. 285/247; 285/249; 285/354

(57) ABSTRACT

A pull-out resistant connector assembly for connecting a fluid supply tube to a fluid handling device is provided. The assembly includes a connecting nut connected to an annular fitting, the nut and fitting securing the tube therebetween. The connecting nut has, within it and extending therearound, a projection having an internal circumferential sharp-edged ridge. The nut is connectable to and over the annular fitting. At its proximal end the fitting has an outside diameter such that the tube is slidable thereover, and the fitting tapers along its length from the outside diameter at its proximal end thereof to a larger outside diameter at its distal end. The fitting has an external projection having an external, circumferential sharp-edged ridge formed therearound. The nut is adapted to receive a length of the fluid supply tube into and through its proximal end and, upon connection of the assembly, the nut and fitting compress the tube therebetween and secure the supply tube thereat by the gripping forces exerted therearound by the sharp-edged ridges. The fitting is adapted at its distal end to connect the internal bore thereof to an inlet port of the fluid handling device.

### FIELD OF THE INVENTION

The invention relates to fittings for connecting fluid supply lines, both gaseous and liquid, to various components in fluid handling apparatus.

### BACKGROUND OF THE INVENTION

Connectors between fluid supply lines and fluid distribution circuits and fluid handling devices are common and varied, and are used in a wide range of industrial applications. Most such connectors must be secure and resistant to pull-out, since a failure of the connection resulting from pull-out can have disastrous consequences. Failures can result in uncontrolled release of contaminants and/or complete disruption and shut down of complex processes. This risk is heightened when the fluid handling system is robotically controlled, wherein additional stresses are imposed on the fittings resulting from movement of the robots, such as occurs, for example, in the electro-static application of paint in the automotive finishing industry.

Applying a finish coating to a vehicle involves supplying various fluids through various sizes of supply tubing at different stages of the process. The different fluids may include paint, atomization air, air for air bearings, solvents, etc. In the painting process, different equipment components may require a plurality of supply lines for a single type of fluid, for example, different colors of paint may be required at a single painting station.

An atomizer may be supplied with several different tubes, differing both in size and material of construction, to control the flow of paint and the atomization of the paint, to maintain a desired paint pattern, to flush and clean the system and to provide a triggering mechanism for several pneumatic valves which may be employed throughout the system apparatus.

Herein, specific reference is made to a robotically controlled vehicle painting operation, a process which is particularly vulnerable to pull-out of supply lines at their respective connections into various component pieces of equipment used in this process. It is to be understood, however, that the pull-out resistant fitting of this invention may be useful in all applications where pull-out problems may arise and are to be avoided. Such wide-ranging applications are many and varied, and will be readily apparent to those skilled in the art.

Heretofore, compression fittings such as the fitting 10 depicted in FIG. 1 have been used to connect tubing 15 to such equipment. The compression fitting 10 of FIG. 1, further illustrated in the cross-section of FIG. 2 taken along line 2-2 of FIG. 1, includes a threaded fitting or nipple 12 which threadingly engages the fluid applicator component 18, which may be a spray device, an atomizer, etc. The fitting 12 has hex-shaped section 17 which allows for wrench tightening and adjustment of the fitting into the component 18. The fluid supply tube 15 is inserted into the proximal, upstream end of the fitting 12 and seats within the fitting at the flat 19. Hex nut 14 is then tightened down on the upper threads of fitting 12, compressing the nylon or other compression ring 16 into the tube 15 as shown in FIG. 2, and completing the compression seal between the inlet supply tube 15 and the bore 22 of the particular fluid handling component 18. Such fittings are used, for example, to connect paint supply tubing to the inlet port of an atomizer or to a color change manifold.

Another type of known fitting is the push lock fitting 20 depicted in FIG. 1 and shown in cross-section in FIG. 3, which section is taken along line 3-3 of FIG. 1. A perspective view of the fitting itself, 20, isolated, is shown in FIG. 4. In FIGS. 1 and 3-4, the fitting 20 includes external flange 26 and separated, insertable extensions 28 which are inserted into a tapered opening 32 in, e.g. a fluid handling manifold 18, as seen in FIG. 3. The extensions 28 have ridges 36 molded therein which, upon insertion, expand to resist pull-out of the fitting 20. A seal is effected by “O”-ring 30 which is compressed on insertion of the fitting, providing a seal between the inserted supply tube 24 and the bore 34 of the fluid handling manifold 18. Such push lock fittings have been used to quickly connect or disconnect air supply tubing, for example.

Another type of hose connecting fitting is a twist-on fitting shown in FIG. 5. FIG. 5 is a simplified perspective view, partly in cross-section, showing a robot side base plate 42 attached to a robot arm (not shown), the plate 42 attached to a base plate 38 of a fluid handling device, e.g., a spray atomizer. Fluid, either gas or liquid, is fed through tube 15 which extends into the base plate 42 through opening 43 therein, and a twist-on fitting 44 is attached to the end of hose 15 by twisting, indicated by the arrow, with the tube 15 being secured therein by engagement with the internal threads 46 in the fitting 44, the threads forming indented groove 50 in tube 15. Inserted into the fitting 44 are “O”-rings 48 as shown, such that, upon connection, the rings 48 form a seal between the supply tube 15 opening into the nipple 40 which extends from base plate 38. The threads 46 provide some gripping force and resistance against pull-out. However, in such a connector, small threads offer limited pull-out resistance against the considerable forces exerted on the tubing during a spraying operation. Conversely, it is not practical to make the raised threads larger because that would allow the threads to cut into the tubing, both weakening it and making it difficult to assemble, the assembly being self-threading.

Compression fittings can be difficult to assemble and disassemble, especially in confined spaces. Push lock fittings are difficult to produce, owing to the complexity of the cavity and fitting, requiring special tooling. Neither is completely satisfactory in providing reliable and adequate resistance to pull-out. The present invention obviates difficulties inherent in prior art fittings.

### SUMMARY OF THE INVENTION

A pull-out resistant connector assembly for connecting a fluid supply tube to a fluid handling device is provided. The assembly includes a connecting nut connected to a fitting, the nut and fitting securing the tube therebetween. The connecting nut has a proximal end and a distal end and has a first internal diameter extending lengthwise within the nut a first predetermined distance from the proximal end thereof, at which distance the internal diameter increases abruptly to a second, larger diameter extending longitudinally a further, second predetermined distance within the nut, thereby forming at the diameter transition an internal projection having a circumferential sharp-edged ridge within the nut at the first distance. The nut is connectable to and over the annular fitting, the fitting also having a proximal end and a distal end and having an internal bore therethrough and a longitudinally tapered external surface thereof. At its proximal end the fitting has an outside diameter such that the tube is slidable thereover, the fitting tapering along its length from the outside diameter at its proximal end thereof to a larger outside diameter, with this larger outside diameter extending longitudinally a distance along the length thereof, at which distance the outside diameter abruptly decreases to a smaller diameter which extends longitudinally a further predetermined distance along the length of the fitting. An external projection having an external circumferential sharp-edged ridge is thereby formed around the fitting at the location of the abrupt diameter change.

The nut is adapted to receive a length of the fluid supply tube into and through its proximal end. Upon connection of the assembly, the tube extends within the nut a distance beyond the first predetermined distance, beyond the sharp-edged ridge in the nut, over the proximal end of the fitting, and extends along and over the fitting a distance beyond the external circumferential sharp-edged ridge thereof. On connection, the nut and fitting compress the tube therebetween and secure the supply tube thereat by the cooperative gripping forces exerted therearound by both sharp-edged ridges. The fitting is adapted at its distal end to connect the internal bore thereof to an inlet port of the fluid handling device.

The nut and fitting are preferably connected by internal threads in the nut mating with external threads on the fitting.

The projections in both the nut and the fitting are preferably tooth shaped in cross-section, and angled distally, thereby providing gripping or biting forces on the tube and resisting tube pull-out. In an alternate embodiment, the projections may each form a right angle.

The assembly is useful for connecting a plastic supply tube, such as a fluoroelastomeric supply tube, to a downstream fluid handling device. The assembly may be used to connect either gas or liquid supply tubes, such as air or paint supply tubes, and is especially suited to connect a plurality of fluid supply tubes to selected inlets in apparatus for spray painting automotive vehicles.

### BRIEF DESCRIPTION OF THE DRAWINGS

In the accompanying drawings,

FIG. 1 depicts two connectors known in the prior art for connecting fluid supply lines to a component of fluid handling apparatus, namely a compression fitting and a push lock fitting.

FIG. 2. is a cross-sectional view of the compression fitting shown in FIG. 1 taken along line 2-2 of FIG. 1.

FIG. 3 is a cross-sectional view of the push lock fitting shown in FIG. 1 taken along line 3-3 of FIG. 1.

FIG. 4 is a perspective view of the conventional push fitting of FIG. 1.

FIG. 5 is a perspective view of a twist-on fitting known in the prior art, partially in cross-section.

FIG. 6 is a perspective view, partly in cross-section, of the pull-out resistant connector assembly of the invention connecting a supply tube to a fluid handling device.

FIG. 7 is an exploded perspective view of a wrench used to connect the assembly components of the invention to a supply tube.

FIG. 8 is an exploded view, partially in cross-section, of the connector assembly of the invention being assembled to connect a fluid supply tube to the nippled opening of a fluid handling device.

FIG. 9 is a schematic elevation, partly in cross-section, of one embodiment of the connector assembly of the invention.

FIG. 10 is a magnified cross-sectional view of a portion of a supply tube which is compressed and secured within the connector assembly of the invention.

FIG. 11 is a schematic elevation, partly in cross-section, of an alternate embodiment of a connector assembly according to the invention.

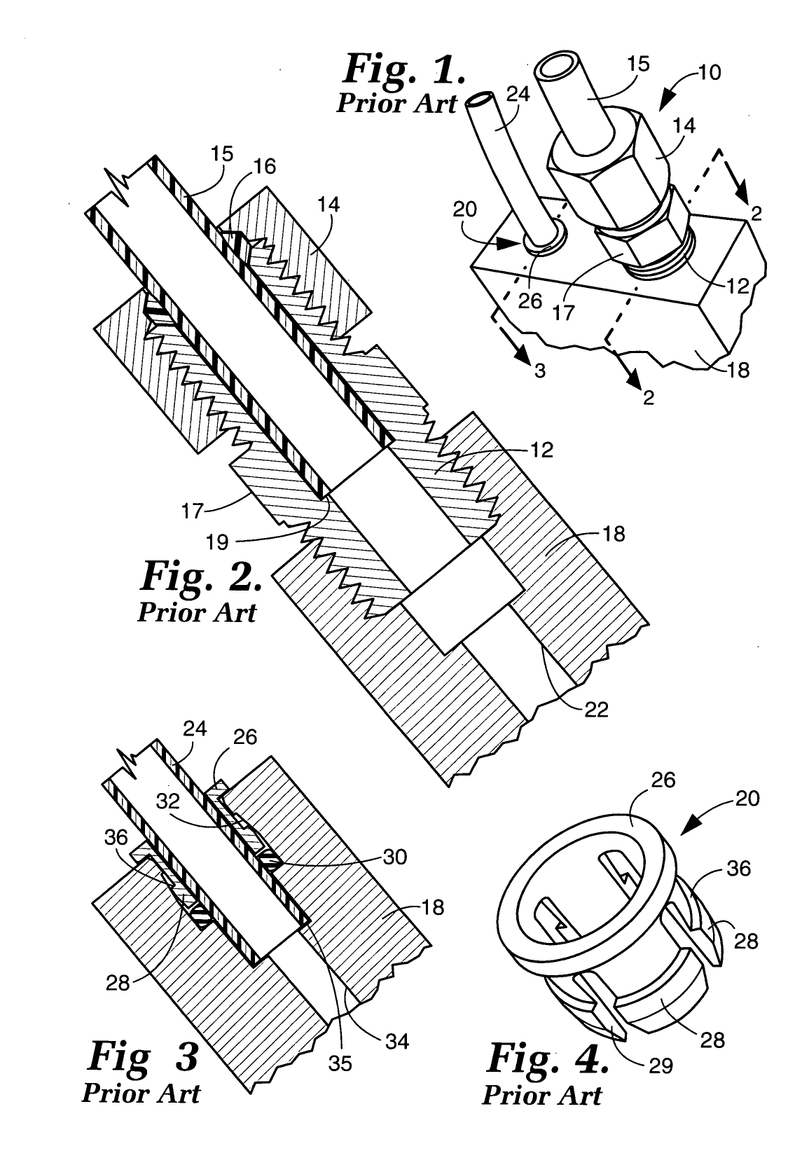

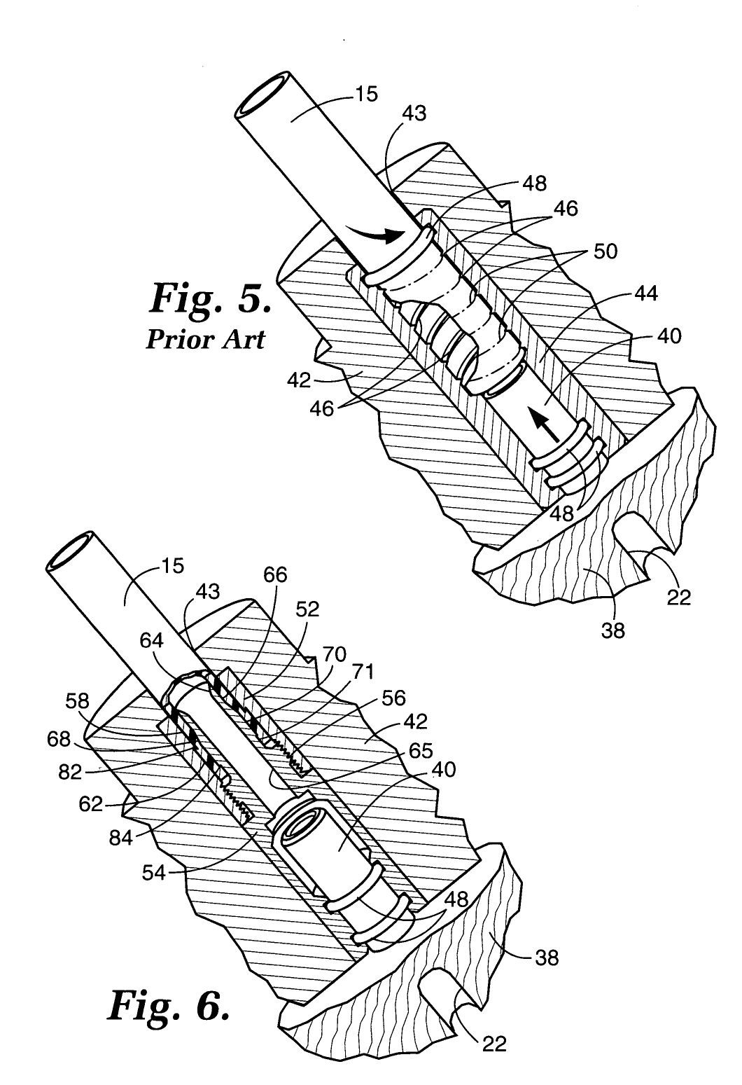

### DETAILED DESCRIPTION OF THE INVENTION AND PREFERRED EMBODIMENTS WITH REFERENCE TO THE DRAWINGS

A pull-out resistant connector assembly for connecting a fluid supply tube to a fluid handling device is provided. The assembly includes a connecting nut connected to an annular fitting, the nut and fitting securing the tube therebetween. The connecting nut has, within it and extending therearound, a projection having an internal circumferential sharp-edged ridge. The nut is connectable to and over the annular fitting. At its proximal end the fitting has an outside diameter such that the tube is slidable thereover, and the fitting tapers along its length from the outside diameter at its proximal end thereof to a larger outside diameter at its distal end. The fitting has an external projection having an external, circumferential sharp-edged ridge formed therearound. The nut is adapted to receive a length of the fluid supply tube into and through its proximal end and, upon connection of the assembly, the nut and fitting compress the tube therebetween and secure the supply tube thereat by the gripping forces exerted therearound by the sharp-edged ridges. The fitting is adapted at its distal end to connect the internal bore thereof to an inlet port of the fluid handling device.

A more specific and detailed description of the invention and preferred embodiments is best provided with reference to the accompanying drawings wherein FIG. 6 depicts, in perspective and partially in cross-section, a preferred embodiment of the pull-out resistant fitting assembly according to the invention. Therein, a fluid supply tube 15, such as a liquid paint supply line, or a line for supplying a gas (air), is connected to a component 38 of a fluid handling device, such as a spray atomizer, by a connector assembly of the invention. The connector assembly is shown extending through a robot-side base plate 42 affixed to plate 38 (such as by bolts, not shown), and includes a nut 52 connected to a fitting 54 by, in this embodiment, mating threads 56 on the nut and fitting. As shown, the fitting 54, is sized so as to sealingly slide over the nipple 40 extending out of plate 38 and be sealed at its distal end in fluid-tight fashion by “O-rings 48.

Nut 52 has a proximal, upstream end into which the tube 15 is inserted. This proximal inside diameter of the nut 52 is somewhat larger than the outside diameter of tube 15, so that slidable insertion of the tube into the nut is easily accomplished.

By definition herein and for ease of reference, the term proximal will denote an upstream location or end of a given component and the term distal will, accordingly, denote a downstream location or end of that part, wherein upstream and downstream both refer to the direction of flow of the fluid being supplied.

The nut 52 has an inside diameter (I.D.) at its proximal end 58 which is larger than tube 15 to permit insertion therein. This I.D. 58 extends longitudinally within nut 52 a first predetermined distance, at which distance the I.D. of the nut increases abruptly to a larger I.D. 62, forming an internal circumferential projection 82 at the transition distance, which projection (82) will be described fully below. The larger I.D. 62 of the nut 52 extends a further, second predetermined longitudinal distance into the nut as shown in the figure.

The fitting 54, shown in this embodiment threadingly mated with nut 52 by threads 56, extends from a proximal tapered entry 64 to central bore 65 which is in sealed fluid communication with the nipple 40 affixed to and connected to fluid handling device 38. The annular fitting 54 has a tapered external surface longitudinally thereof as shown in FIG. 6. The outside diameter (O.D.) 66 of the fitting at the proximal end is such that tube 15 is slidable thereover. The O.D. 66 of the fitting extends longitudinally an initial length as shown in FIG. 6 and then tapers outwardly along a tapered length 68 to a somewhat larger outside diameter 70, at which distance the fitting's outside diameter abruptly decreases to O.D. 71, which then continues essentially to the external threads 56 of the fitting 54. When connected, by the threads 56 in the embodiment shown, the tube 15 is inserted into the nut 52 a substantial distance and the proximal end of the fitting 54 is inserted into the end of the tube 15. The fitting is then tightened down such that the tube is forced over the external surface thereof, over the proximal O.D. 66 of the fitting, over the taper 68 and over the larger O.D. 70 of the fitting, extending over the projection 84 (described below), the fitting 54 and the nut 52 compressing the tube 15 within and between the nut and the fitting. The entire assembly may be held together by bolts (not shown) which affix the robot side base plate 42 to the fluid handling component 38.

In a typical fluid handling (e.g., spray painting) operation, the tube 15 may be a plastic tube such as a fluoroelastomeric tube, which is inert to most fluids. The nut 52 and the fitting 54 may be of any suitable material, plastic or metal, and may include polyacetals or polycarbonates, or steel or stainless steel, for particular applications. Fluid handling components, “O”-rings, and auxiliary attachment components are conventional. Materials of construction for a particular application will be a matter of design choice.

FIG. 7 illustrates a tool useful in the installation of the connector assembly of the invention. Therein, tube 15 is shown extending into nut 52, which has external indents 78 positioned around the proximal end thereof. The nut 52 is threadable onto the fitting 54, as indicated by the arrows. In this figure, the proximal O.D. 66, the tapering surface 68, and the distal O.D.'s 70 and 71 of the fitting 54, over which the tube 15 slidingly engages the fitting, are more clearly seen. The flats 55 permit a wrench to grip and tighten the fitting. To do so, a wrench (not shown) first secures the fitting 54. The tool, having split body 72 with slot 74 to accommodate the tube, then engages the indents 78 in the nut 52 by means of detents 76 and the nut and fitting are tightened down by turning handles 80 while holding the wrench.

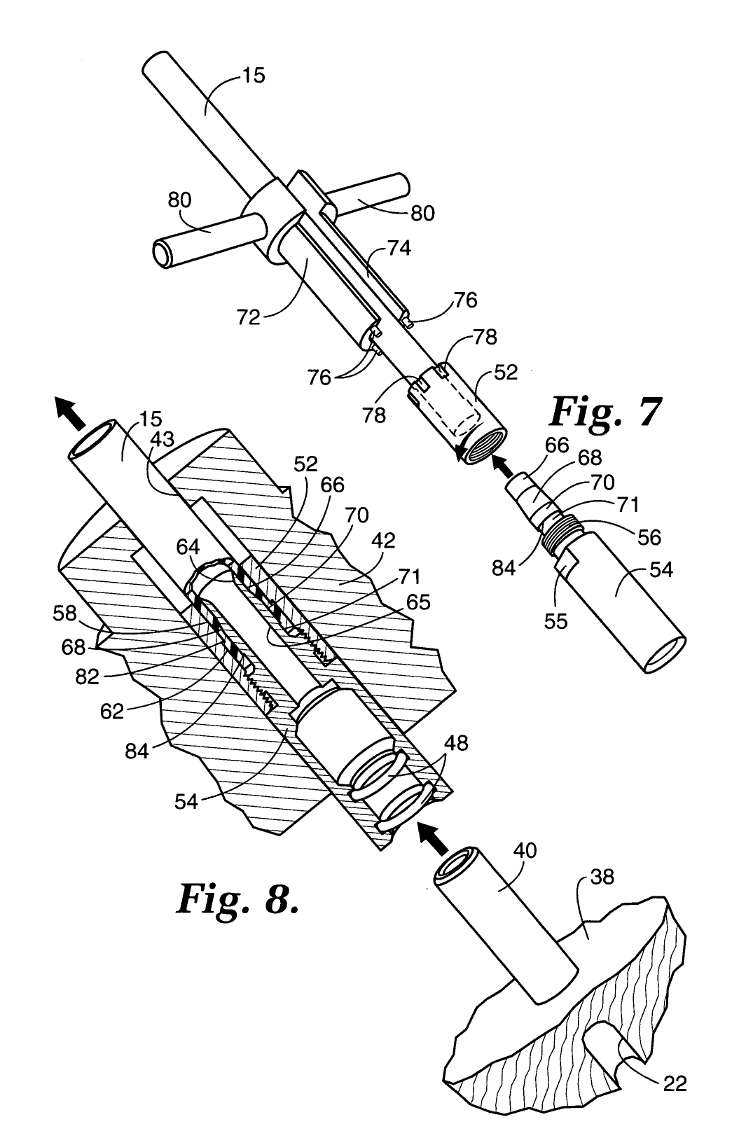

The procedure for assembly of the fitting is further illustrated in FIG. 8. Having inserted the tube 15 through the opening 43 in the backing plate 42, and exposing the end of the tube, the tube 15 is inserted into the nut 52 as shown. The proximal end of the fitting 54 is inserted into the end of the tube, and the fitting and nut are tightened down to force the tube 15 to slide over the external surfaces 66, 68, 70 and 71 of the fitting 54 and be compressed as shown between the fitting 54 and the nut 52. The assembly is completed by slidably engaging the fitting 54 over the nipple 40 and securing the base plate 42 to the component 38 of the fluid handling apparatus, e.g., by bolts, not shown.

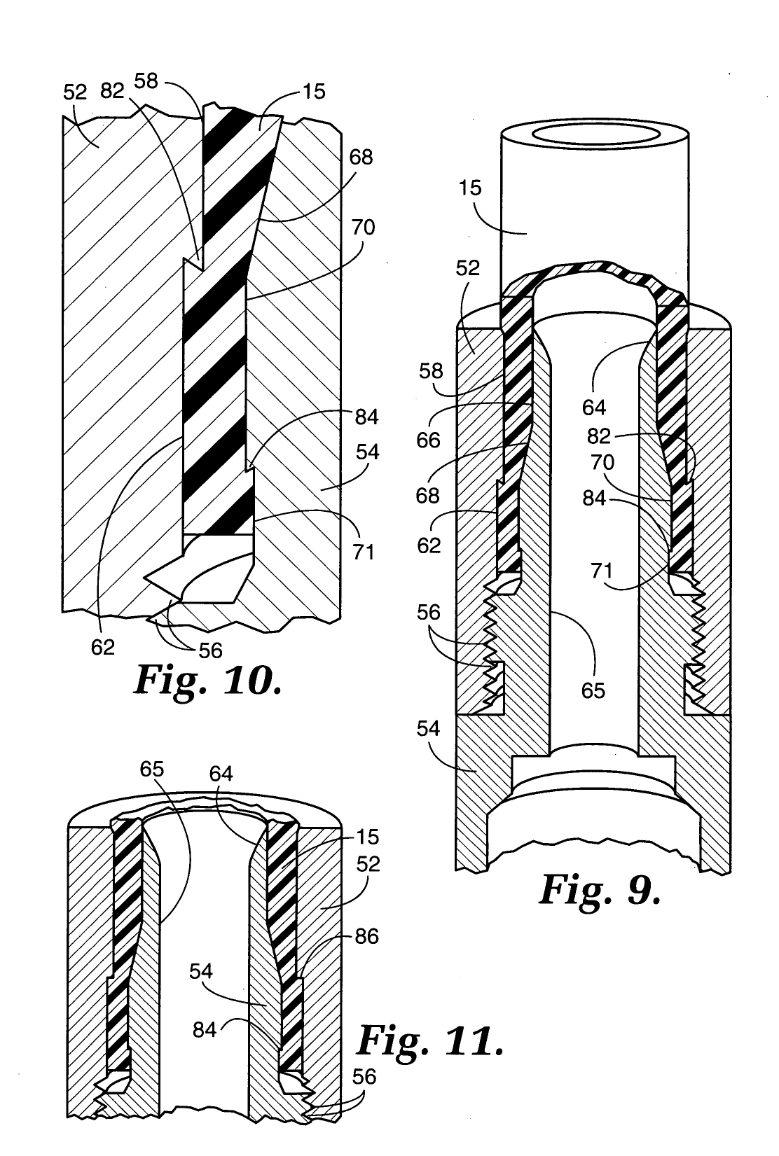

A key to the pull-out resistant fitting of the invention is illustrated in more detail in FIGS. 9 and 10. FIG. 9 shows the completed fitting and nut assembly and the circumferential projections 82 and 84, both having sharp-edged ridges as shown, which act as cooperating gripping means to resist and prevent the tube 15 from pulling out of the connector assembly, even on application of sizable pull-out forces. The proximal I.D. 58 of the nut 52 extends along the nut for the aforesaid first distance to an abrupt change, to larger I.D. 62, whereat the projection 82 is formed having the sharp edge shown which bites into and grips the tube 15 upon assembly of the connection. Cooperatively, the fitting 54 extends within the nut 52 causing the tube 15 to be forced over its external proximal O.D. 66, over the taper 68 and over the larger O.D. 70 thereof, at which point the fitting outside diameter 70 abruptly decreases to O.D. 71, thereby forming the projection 84 having its sharp-edged ridge as shown extending circumferentially around the tube and gripping it.

A magnified view of both projections 82 and 84 is shown in FIG. 10. Therein, fitting 54 extends into nut 52, and tube 15 is compressed in the gap between the nut 52 and fitting 54. The tube extends over the taper 68 of the fitting and over the larger O.D. 70 of the fitting to the point whereat the fitting outside diameter abruptly decreases to O.D. 71 as shown, thereby forming the circumferential projection 84 having its sharp-edged ridge as shown.

The proximal inside diameter 58 of the nut 52 abruptly increases to the I.D. 62 illustrated in FIG. 10, thereby forming the projection 82 at the transition. The two projections 82, 84, which are shown to be tooth shaped in the figures, a preferred configuration, act cooperatively to restrain the tube 15 against pull-out. These tooth-shaped projections 82, 84 are also preferably angled distally, as also illustrated in FIGS. 9 and 10, to further enhance the biting forces and restrain pull-out.

FIG. 11 illustrates an alternate embodiment of the invention wherein the projection 86 forms a right-angled sharp step for gripping and retaining tube 15. This embodiment may be useful in certain applications,

While the invention has been disclosed herein in connection with certain embodiments and detailed descriptions, it will be clear to one skilled in the art that modifications or variations of such details can be made without deviating from the gist of this invention, and such modifications or variations are considered to be within the scope of the claims hereinbelow.

1. A pull-out resistant connector assembly for connecting a fluid supply tube to a fluid handling device, the assembly comprising:
a connecting nut having a proximal end and a distal end and having a first internal diameter extending longitudinally into said nut a first predetermined distance from the proximal end thereof, at which distance the internal diameter increases to a second, larger diameter extending longitudinally a further, second predetermined distance into said nut, thereby forming at the diameter transition an internal projection having a circumferential sharp-edged ridge at said first distance, the nut being connectable to and over
an annular fitting having a proximal end and a distal end and having an internal bore therethrough and a longitudinally tapered external surface thereof, said fitting having at its proximal end an outside diameter such that said tube is slidable thereover, said fitting tapering along its length from said outside diameter at its proximal end thereof to a larger outside diameter, this larger outside diameter extending a distance along the length thereof, at which distance the outside diameter decreases to a smaller diameter which extends longitudinally a further predetermined distance along the length of said fitting, thereby forming an external projection having a circumferential sharp-edged ridge around said fitting at said distance,
said nut adapted to receive a length of said fluid supply tube into and through its proximal end, wherein, upon connection of said assembly, said tube extends within said nut a distance beyond said first predetermined distance, beyond said internal projection in said nut, over the proximal end of said fitting, and extends along and over said fitting a distance beyond said external circumferential projection thereof,
said nut and said fitting compressing said tube therebetween upon connection and securing said supply tube thereat, the fitting adapted at its distal end to connect said internal bore to an inlet port of said fluid handling device.

2. The assembly of claim 1 connecting a fluid supply tube to a nippled inlet of a fluid handling device.

3. The assembly of claim 1 wherein said nut and said fitting are connected by internal threads in the nut mating with external threads on the fitting.

4. The assembly of claim 1 wherein said projection in said nut is tooth-shaped in cross-section, angled distally, thereby providing a biting force resisting tube pull-out.

5. The assembly of claim 1 wherein said projection around said fitting is tooth-shaped in cross-section, angled distally, thereby providing a biting force resisting tube pull-out.

6. The assembly of claim 1 wherein said projection in said nut forms a right angle.

7. The assembly of claim 1 wherein said projection around said fitting forms a right angle.

8. The assembly of claim 1 wherein both the projection in said nut and the projection in said fitting are tooth-shaped in cross-section, and both are angled distally.

9. The assembly of claim 1 wherein said fluid supply tube is a plastic tube.

10. The assembly of claim 9 wherein said plastic tube is a fluoroelastomeric tube.

11. The assembly of claim 1 wherein said fluid is a gas.

12. The assembly of claim 11 wherein said fluid is air.

13. The assembly of claim 1 wherein said fluid is a liquid.

14. The assembly of claim 13 wherein said fluid is paint.

15. The assembly of claim 13 wherein said fluid is water.

16. The assembly of claim 13 wherein said fluid is a solvent.

17. The assembly of claim 1 wherein said fluid is a coating material.

18. The assembly of claim 17 wherein said coating material is a fluidized powder.

19. The assembly of claim 1 connected to a spray gun paint applicator.

20. The assembly of claim 1 connected to a rotary spray applicator.

21. The assembly of claim 1 connected to a robotically controlled fluid handling device.

22. The assembly of claim 21 connected to a robotically controlled spray gun.

23. The assembly of claim 21 connected to a robotically controlled rotary spray applicator.

24. The assembly of claim 21 connecting at least one fluid supply tube to spray apparatus for spray painting an automotive vehicle.

25. A plurality of the assemblies of claim 1 connecting a plurality of fluid supply tubes to selected inlets in apparatus for spray painting automotive vehicles.
